(19) United States
(12) Patent Application Publication
(10) Pub. No.: US 2012/0315836 A1
(43) Pub. Date: Dec. 13, 2012

(54) ASSEMBLY FOR HEATING, VENTILATING AND CONDITIONING AIR IN AN AUTOMOBILE

(75) Inventor: ARDEEAN SCOCCIA, AMHERST, NY (US)

(73) Assignee: DELPHI TECHNOLOGIES, INC., TROY, MI (US)

(21) Appl. No.: 13/154,845

(22) Filed: Jun. 7, 2011

(51) Int. Cl. B60H 1/24

(52) U.S. Cl. 454/143

(57) ABSTRACT

An assembly for heating, ventilating and conditioning air in an automobile including an air inlet case chamber for receiving air. The air inlet case has a recirculation air inlet for receiving recirculation air from the passenger compartment of the automobile and an ambient air inlet for receiving ambient air from outside of the automobile. The air inlets are disposed adjacent to one another. An inlet valve plate is pivotally supported between the air inlets for rotation between a recirculation position, an ambient air position, and a partial recirculation position therebetween. The assembly further includes a check valve disposed in the recirculation air inlet adjacent the inlet valve plate. The check valve allows recirculation air to flow from the passenger compartment to the air inlet case chamber and prevents air from flowing from the air inlet case chamber to the passenger compartment when the valve plate is in the partial recirculation position.

### BACKGROUND OF THE INVENTION

1. Field of the Invention

An assembly for heating, ventilating and conditioning air in an automobile.

2. Description of Related Art

Assemblies for heating, ventilating and conditioning air in automobiles are widely used in the automobile industry. One such assembly is disclosed in U.S. Pat. No. 6,077,158. The '158 patent discloses an air inlet case defining a chamber for receiving air for selectively heating and ventilating and conditioning. The air inlet case has a recirculation air inlet for receiving recirculation air from the passenger compartment of the automobile in a first direction into the chamber. The air inlet case also has an ambient air inlet for receiving ambient air from outside of the automobile into the chamber. The air inlets are disposed adjacent to one another. Further, the '158 patent discloses an inlet valve plate pivotally supported between the air inlets for rotation between a recirculation position, an ambient air position, and a partial recirculation position therebetween. When the valve plate is in the recirculation position, the ambient air inlet is sealed for allowing only recirculation air to flow into the chamber. When the valve plate is in the ambient position, the recirculation air inlet is sealed for allowing only ambient air flow into the chamber. When the valve plate is in the partial recirculation position, the recirculation air inlet and the ambient air inlet are both partially opened. Thus, the amount of ambient air and recirculation air flowing into the chamber is proportioned.

In the assemblies of the prior art, when the partial recirculation mode is selected, vehicle speed is high, and fan speed is low, high pressure in the inlet case chamber causes unconditioned fresh air to flow in reverse from the chamber to the passenger compartment. Often, this will result in occupant discomfort. For example, unconditioned cold air flows into the passenger compartment in the winter, and unconditioned hot air flows into the passenger compartment in the summer The '158 patent addresses this issue by forcing the inlet valve plate into the ambient air position.

### SUMMARY OF THE INVENTION

The invention provides for such an assembly for heating, ventilating, and conditioning air in an automobile. The assembly includes a check valve disposed in the recirculation air inlet adjacent the inlet valve plate. When the inlet valve plate is in the partial recirculation position, the check valve allows recirculation air to flow from the passenger compartment to the air inlet case chamber in the first direction in an open position, and prevents air from flowing from the air inlet case chamber to the passenger compartment in a second direction opposite the first direction in a closed position.

Thus several advantages of one or more aspects of the invention are that the invention provides for increased passenger comfort because the check valve prevents unconditioned fresh air from entering the vehicle cabin from the inlet case chamber. Further, the present invention allows the inlet valve plate to remain in the partial recirculation position when the vehicle is operating at high speeds, advantageously reducing costs associated with implementing additional control logic to move the valve plate, and eliminating noises associated with valve plate movement. Further, the single recirculation opening faces the front of the dash of the automobile, advantageously providing a significant noise transmission reduction compared to traditional openings that face the passenger compartment.

### BRIEF DESCRIPTION OF THE DRAWING(S)

Advantages of the present invention will be readily appreciated as the same becomes better understood by reference to the following detailed description and the accompanying drawings that set forth an exemplary embodiment wherein:

FIG. 1 is a side view of the assembly with the inlet plate valve in the partial recirculation position;

FIG. 2 is a side view of the assembly with the inlet plate valve in the recirculation position;

FIG. 3 is a side view of the assembly with the inlet plate valve in the ambient air position;

FIG. 4 is an exploded view of the check valve;

FIG. 5 is a side view of the check valve in the opened position; and

FIG. 6 is a side view of the check valve in the closed position.

### DETAILED DESCRIPTION OF THE EXEMPLARY EMBODIMENT(S)

Referring to the Figures, wherein like numerals indicate corresponding parts throughout the several views, an assembly 20 for heating and ventilating and conditioning air in an automobile defining a passenger compartment 22 is generally shown.

The assembly 20 includes an air inlet case 24 defining a chamber 26 for receiving air for selectively heating and ventilating and conditioning. The air inlet case 24 includes a recirculation air inlet 28 and an ambient air inlet 30 disposed adjacent to one another. The recirculation air inlet 28 is for receiving recirculation air from the passenger compartment 22 of the automobile in a first direction A into the chamber 26. The ambient air inlet 30 is for receiving ambient from outside of the automobile into the chamber 26.

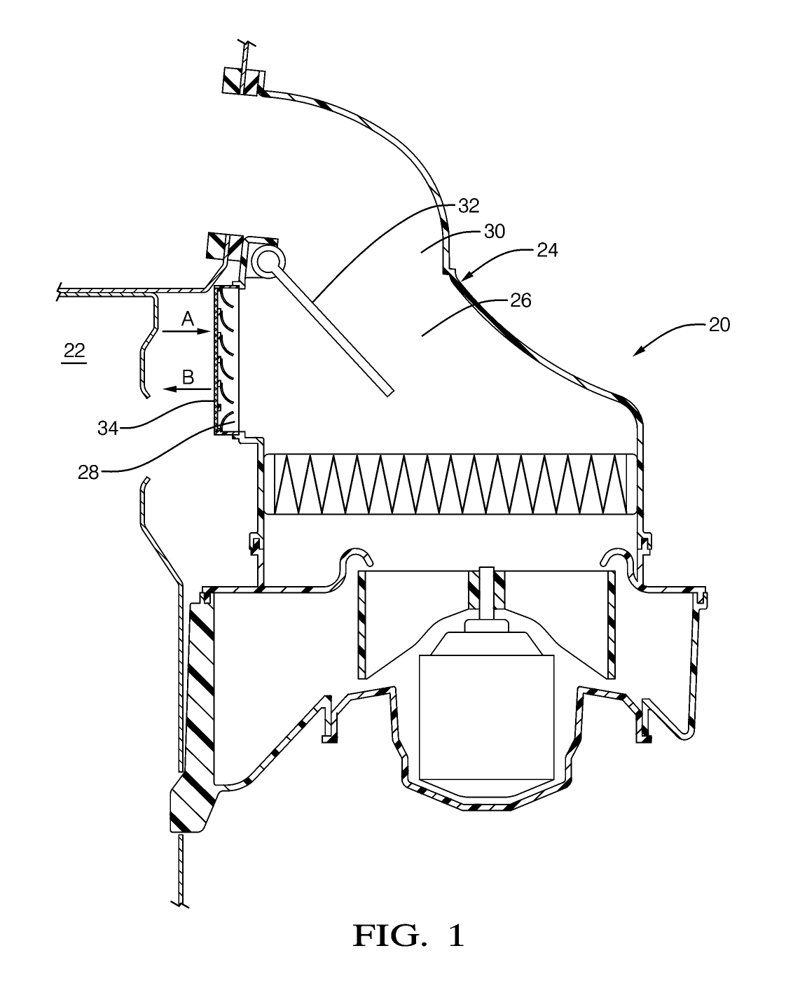

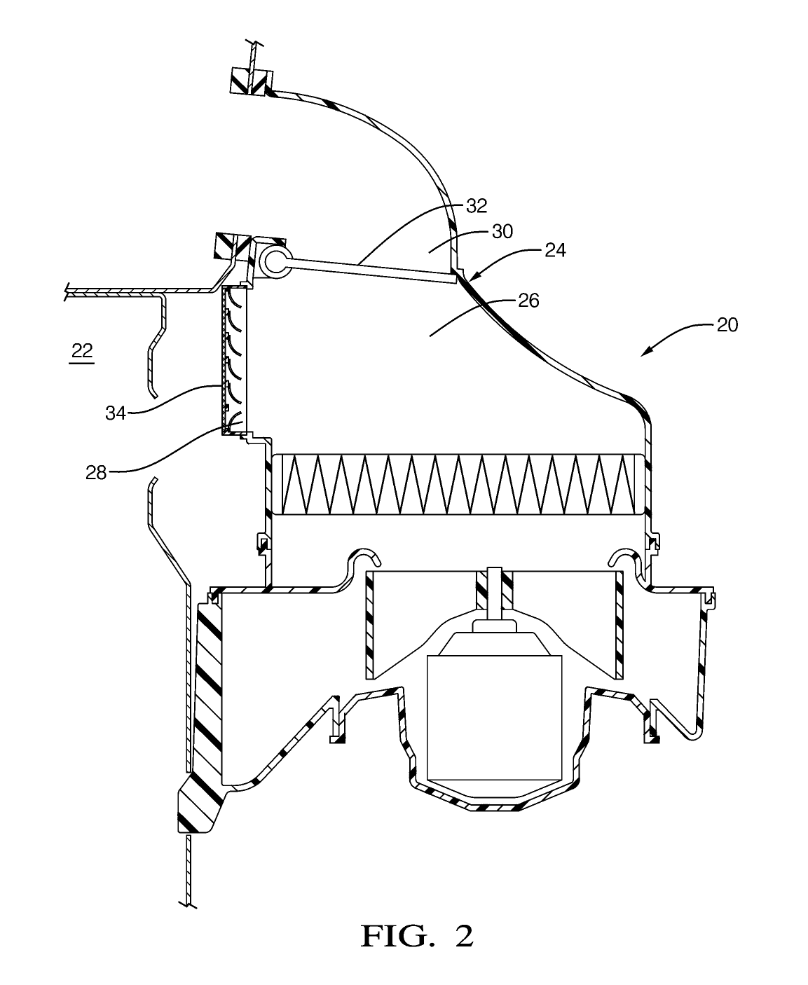

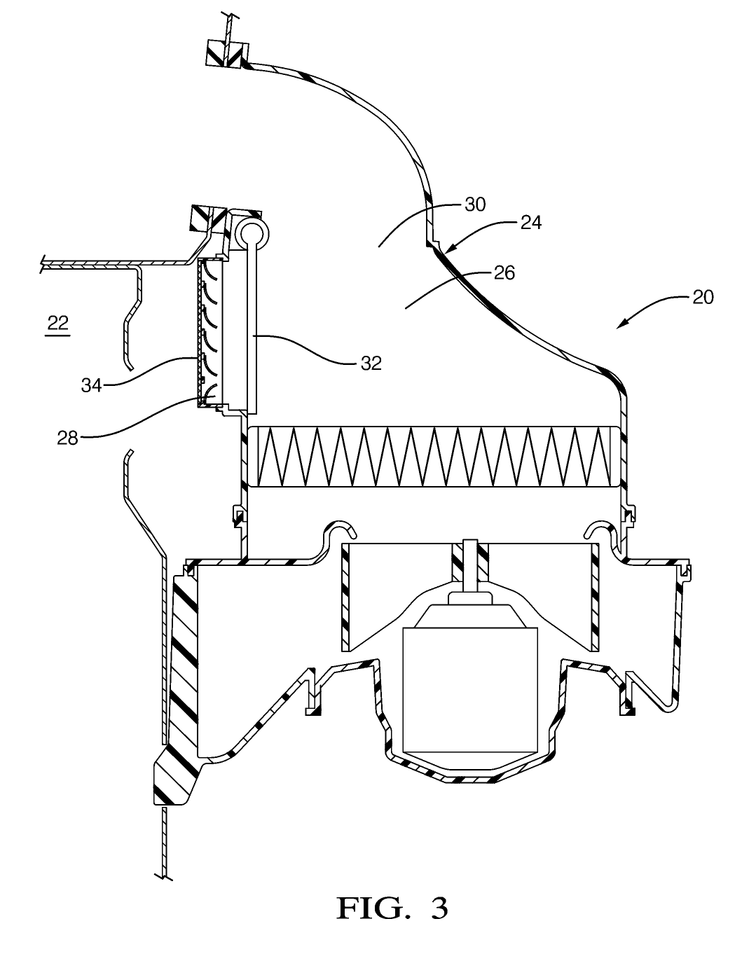

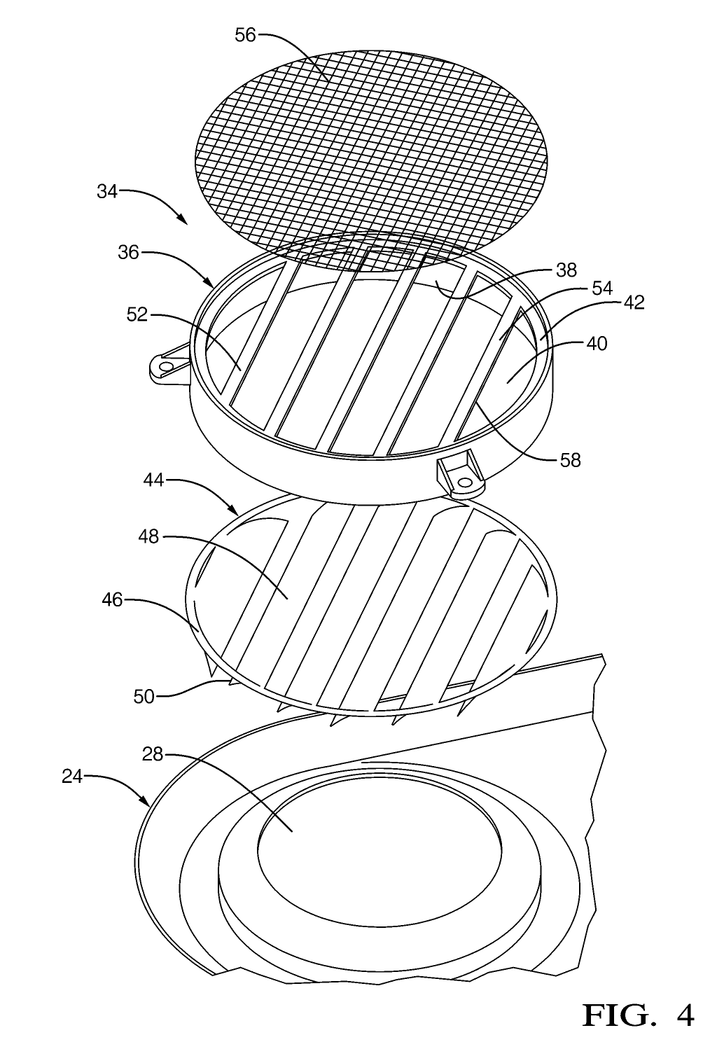

An inlet valve plate 32 is pivotally supported between the two air inlets 28, 30 for rotation between a recirculation position as best shown by FIG. 2, an ambient position as best shown by FIG. 3 and a partial recirculation position as best shown by FIG. 1. When the valve plate 32 is in the recirculation position, the valve plate 32 sealingly shuts the ambient air inlet 30, only allowing recirculation air to flow into the chamber 26. When the valve plate 32 is in the ambient position, it sealingly shuts the recirculation air inlet 28, only allowing ambient air to flow into the chamber 26. The recirculation air inlet 28 and the ambient air inlet 30 are both partially open when the inlet valve plate 32 is in the partial recirculation position. Thus, the amount of ambient air and recirculation air flowing into the chamber 26 is proportioned.

A check valve 34 is disposed in the recirculation air inlet 28 adjacent the inlet valve plate 32. The opening and closing of the check valve 34 is passively activated, based on the pressure difference between the passenger compartment 22 and the chamber 26. When the inlet valve plate 32 is in the partial recirculation position and the pressure is lower in the chamber 26 than that of the passenger compartment 22, the check valve 34 allows recirculation air to flow from the passenger compartment 22 to the chamber 26 in the first direction A in an open position. When the pressure is greater in the chamber 26 than that of the passenger compartment 22, the check valve 34 prevents air from flowing from chamber 26 to the passenger compartment 22 in a second direction B opposite the first direction A in a closed position. Specifically, the pressure in the chamber 26 tends to be greater than the pressure in the passenger compartment 22 when the vehicle is operating at high speeds. This invention prevents passenger discomfort resulting from unconditioned air entering the passenger compartment 22 from the chamber 26 when the vehicle is operating at high speeds.

Further, when the inlet valve plate 32 is in the ambient position, the pressure in the chamber 26 can be very high. To prevent leaking of over-pressured air from the chamber 26 and through the check valve 34 to the passenger compartment 22, the inlet plate overlies and is sealed with the check valve 34 when the inlet valve plate 32 is in the ambient position.

The check valve 34 includes a frame 36 supported by the inlet case 24 in the recirculation air inlet 28. In the enabling embodiment, the frame 36 has a cylindrical shape and is constructed of an organic polymeric material. However, it should be appreciated that the valve could have any shape and could be constructed of various materials. The frame 36 has a frame inner surface 38 defining a frame interior 40. A frame lip 42 extends radially inwardly from the frame interior 40.

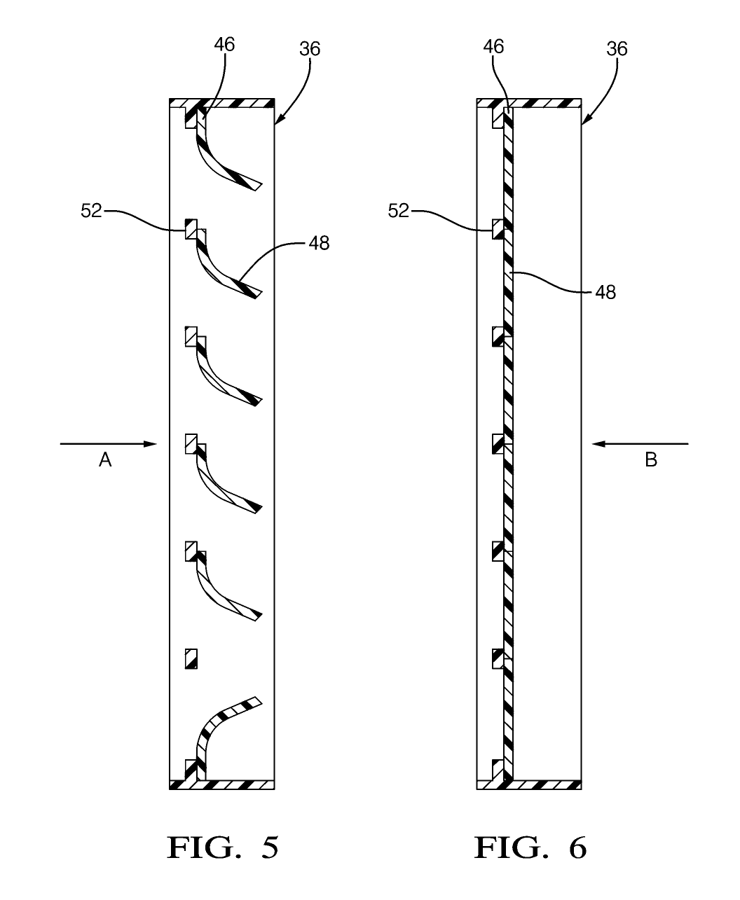

The check valve 34 further includes a membrane 44 constructed of a flexible material defining an outer perimeter 46. The outer perimeter 46 of the membrane 44 abuts and is supported by the frame lip 42. In the enabling embodiment, the membrane 44 is constructed of rubber and it has a circular shape. However, it should be appreciated that various flexible materials could be used and the membrane 44 could have any shape. In the enabling embodiment, the outer perimeter 46 of the membrane 44 is secured to the frame lip 42 by use of an adhesive. However, it should be appreciated that various methods of securing the membrane 44 to the frame lip 42 could be used. The membrane 44 further includes a plurality of flaps 48 extending across the frame 36 in spaced and parallel relationship with one another. Each of the flaps 48 define a lower flap edge 50 for flexing to define the opened position for allowing air to flow through the check valve 34 in the first direction A as best shown in FIG. 5. Further, the lower flap edge flexes to define the closed position for preventing air from flowing through the check valve 34 in the second direction B as best shown in FIG. 6.

The frame 36 further includes a plurality of seat stringers 52 extending across the frame 36 and in spaced and parallel relationship with one another. Each of the seat stringers has a chamber side 54 and a compartment side 58. When the flaps 48 are in the closed position, each of the seat stringers 52 engage at least one of the flap edges 50 on the chamber side 54 for preventing air from flowing through the check valve 34 in the second direction B.

The check valve 34 also includes a debris screen 56 for preventing debris from entering the check valve 34 in the first direction A. The debris screen 56 abuts the passenger compartment side 58 of the seat stringers 52. In the enabling embodiment, the debris screen 56 has a circular shape. However, it should be appreciated that various shapes could be used.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An assembly for heating and ventilating and conditioning air in an automobile defining a passenger compartment comprising;
an air inlet case defining a chamber for receiving air for selectively heating and ventilating and conditioning,
said air inlet case defining a recirculation air inlet for receiving recirculation air from the passenger compartment of the automobile in a first direction into said chamber and defining an ambient air inlet for receiving ambient air from outside of the automobile into said chamber,
said air inlets being disposed adjacent to one another,
an inlet valve plate pivotally supported between said air inlets for rotation between a recirculation position for sealing said ambient air inlet for allowing only recirculation air to flow into said inlet case chamber and an ambient position sealing said recirculation air inlet for allowing only ambient air flow into said inlet case chamber and a partial recirculation position therebetween for proportioning ambient air and recirculation air to flow into said inlet case chamber,
a check valve disposed in said recirculation air inlet adjacent said inlet valve plate for allowing recirculation air to flow from the passenger compartment to said air inlet case chamber in said first direction in an open position and preventing air from flowing from said air inlet case chamber to the passenger compartment in a second direction opposite said first direction in a closed position when said valve plate is in said partial recirculation position.

2. The assembly as set forth in claim 1 wherein said inlet valve plate overlies and is sealed with said check valve when said inlet valve plate is in said ambient position for preventing leaking of over-pressured air from said chamber and through said check valve to the passenger compartment.

3. The assembly as set forth in claim 2 wherein said check valve includes a frame supported by said inlet case and having a frame inner surface defining a frame interior.

4. The assembly as set forth in claim 3 wherein said frame has a cylindrical shape.

5. The assembly as set forth in claim 3 wherein said frame is constructed of an organic polymeric material.

6. The assembly as set forth in claim 3 wherein said check valve includes a membrane of flexible material defining an outer perimeter.

7. The assembly as set forth in claim 6 wherein said frame includes a frame lip extending radially inwardly from said frame interior and said membrane outer perimeter is supported on said frame lip.

8. The assembly as set forth in claim 7 wherein said membrane includes a plurality of flaps extending across said frame in spaced and parallel relationship with one another.

9. The assembly as set forth in claim 8 wherein said periphery of said membrane is circular.

10. The assembly as set forth in claim 8 wherein said material for flexing is rubber.

11. The assembly as set forth in claim 8 wherein each of said flaps define a lower flap edge for flexing to define said open position for allowing air to flow through said check valve in said first direction and said closed position for preventing air from flowing through said check valve in said second direction.

12. The assembly as set forth in claim 11 wherein said frame includes a plurality of seat stringers extending across said frame and in spaced and parallel relationship to one another wherein each of said stringers has a chamber side and a compartment side with each of said seat stringers engaging at least one of said flap edges on said chamber side when said flaps are in said closed position for preventing air from flowing through said check valve in said second direction.

13. The assembly as set forth in claim 12 wherein said check valve further includes a debris screen for preventing debris from entering said check valve in said first direction.

14. The assembly as set forth in claim 13 wherein said debris screen abuts said compartment side of said seat stringers.

15. The assembly as set forth in claim 14 wherein said frame and said debris screen have a circular shape.

16. An assembly for heating and ventilating and conditioning air in an automobile defining a passenger compartment comprising;
an air inlet case defining a chamber for receiving air for selectively heating and ventilating and conditioning,
said air inlet case defining a recirculation air inlet for receiving recirculation air from the passenger compartment of the automobile in a first direction into said chamber and defining an ambient air inlet for receiving ambient air from outside of the automobile into said chamber,
said air inlets being disposed adjacent to one another,
an inlet valve plate pivotally supported between said air inlets for rotation between a recirculation position for sealing said ambient air inlet for allowing only recirculation air to flow into said inlet case chamber and an ambient position sealing said recirculation air inlet for allowing only ambient air flow into said inlet case chamber and a partial recirculation position therebetween for proportioning ambient air and recirculation air to flow into said inlet case chamber,
a check valve disposed in said recirculation air inlet adjacent said inlet valve plate for allowing recirculation air to flow from the passenger compartment to said air inlet case chamber in said first direction in an open position and preventing air from flowing from said air inlet case chamber to the passenger compartment in a second direction opposite said first direction in a closed position when said valve plate is in said partial recirculation position,
said inlet valve plate overlying and is sealed with said check valve when said inlet valve plate is in said ambient position for preventing leaking of over-pressured air from said chamber and through said check valve to the passenger compartment,
said check valve including a frame constructed of an organic polymeric material supported by said inlet case and having a cylindrical shape and a frame inner surface defining a frame interior,
said check valve including a membrane constructed of a rubber material for flexing having a circular shape defining an outer perimeter,
said frame including a frame lip extending radially inwardly from said frame interior,
said frame lip supporting said membrane outer perimeter,
said membrane including a plurality of flaps extending across said frame in spaced and parallel relationship with one another,
each of said flaps defining a lower flap edge for flexing to define said opened position for allowing air to flow through said check valve in said first direction and said closed position for preventing air from flowing through said check valve in said second direction,
said frame including a plurality of seat stringers extending across said frame and in spaced and parallel relationship with one another wherein each of said seat stringers has a chamber side and a compartment side with each of said seat stringers engaging at least one of said flap edges on said chamber side when said flaps are in said closed position for preventing air from flowing through said check valve in said second direction,
said check valve including a debris screen having a circular shape abutting said passenger compartment side of said seat stringers for preventing debris from entering said check valve in said first direction.
